(19) United States
(12) Patent Application Publication
(10) Pub. No.: US 2025/0141496 A1
(43) Pub. Date: May 1, 2025

(54) INDUCTIVE TELEMETRY POWER MODES

(71) Applicant: Cardiac Pacemakers, Inc., St. Paul, MN (US)

(72) Inventors: Paul Huelskamp, St. Paul, MN (US); Scot C. Boon, Lake Elmo, MN (US); Imelda Wang, Edina, MN (US); Kevin G. Wika, Blaine, MN (US)

(21) Appl. No.: 18/916,338

(22) Filed: Oct. 15, 2024

Related U.S. Application Data
(60) Provisional application No. 63/546,093, filed on Oct. 27, 2023.

(51) Int. Cl. H04B 5/73; H04B 5/24

(52) U.S. Cl. CPC H04B 5/73; H04B 5/24

(57) ABSTRACT

Systems and methods are disclosed to an ambulatory medical device comprising a coil antenna, a transceiver circuit, and a control circuit. The transceiver circuit includes a receiver to detect a communication signal received by the coil antenna. The control circuit includes a timeout timer and is configured to set the receiver to an active mode, set the receiver to an inactive mode when the timeout timer expires after a first timeout duration and the communication signal is not detected by the receiver, maintain the receiver in the active mode when the communication signal is detected by the receiver before the timeout timer expires, decode a command in the communication signal to set the timeout timer to a second timeout duration, and set the receiver to the inactive mode when the timeout timer expires after the second timeout duration and the communication signal is not detected.

### CLAIM OF PRIORITY

This application claims the benefit of U.S. Provisional Application No. 63/546,093, filed on Oct. 27, 2023, which is hereby incorporated by reference in its entirety.

### TECHNICAL FIELD

This document relates generally to medical devices and more particularly to systems, methods, and devices for wireless communication between medical devices.

### BACKGROUND

Ambulatory medical devices (AMDs), including implantable, subcutaneous, wearable, or one or more other medical devices, etc., can monitor, detect, or treat, various conditions including, among other things, heart failure (HF), fibrillation, and myocardial infarction. AMDs can be used to treat patients using electrical or other therapy or to aid a physician or caregiver in patient diagnosis through internal monitoring of a patient's condition. The devices may include one or more electrodes in communication with one or more sense amplifiers to monitor electrical heart activity within a patient, and often include one or more sensors to monitor one or more other internal patient parameters. Patient treatment can be adjusted by changing parameters related to detection of the patient's condition and the therapy provided by the device. It is desirable to a physician to customize a device to a specific patient's condition.

### SUMMARY

Systems and methods are disclosed for ambulatory medical devices with changeable telemetry power modes. In a first example (Example 1), an ambulatory medical device (AMD) includes a coil antenna configured to receive a communication signal using mutual inductance, a transceiver circuit operatively coupled to the coil antenna and including a receiver configured to detect the communication signal, and a control circuit including a timeout timer. The control circuit is configured to set the receiver to an active mode, set the receiver to an inactive mode when the timeout timer expires after a first timeout duration and the communication signal is not detected by the receiver, maintain the receiver in the active mode when the communication signal is detected by the receiver before the timeout timer expires, decode a command in the communication signal to set the timeout timer to a second timeout duration, and set the receiver to the inactive mode when the timeout timer expires after the second timeout duration and the communication signal is not detected.

In Example 2, the subject matter of Example 1 optionally includes a control circuit configured to maintain the receiver in the active mode when a first specified type of communication signal is detected before the timeout timer expires, decode a command received by the receiver to select a second specified type of communication signal to detect to maintain the receiver in the active mode, set the receiver to the inactive mode when the timeout timer expires and the second specified type of communication signal is not detected, and maintain the receiver in the active mode when detecting the second specified type of communication signal before the timeout timer expires.

In Example 3, the subject matter of Example 2 optionally includes a control circuit configured to detect, as the first specified type of communication signal, one of a communication signal including a peak with a magnitude greater than a specified signal detection magnitude, a communication signal including a predetermined synchronization character, or a communication signal including a valid command word. The control circuit is configured to detect, as the second specified type of communication signal, a different type of communication signal than the first type of communication signal.

In Example 4, the subject matter of one or any combination of Example 1-3 optionally includes a control circuit configured to maintain the receiver in the active mode when the communication signal includes a peak having a first polarity, decode a command received by the receiver to change to detecting the communication signal when detecting a peak in the communication signal having a second polarity, and maintain the receiver in the active mode when detecting that the communication signal has the second polarity.

In Example 5, the subject matter of one or any combination of Examples 1-4 optionally includes a receiver including an automatic gain control (AGC) amplifier circuit having adjustable gain, and a control circuit configured to increment an activation counter when detecting the communication signal and maintaining the receiver in the active mode, increment a valid communication counter when the communication signal is included in a valid communication with the ambulatory medical device, compare a count of the activation counter and a count of the valid communication counter, and change the gain of the AGC amplifier circuit according to a difference between the count of the activation counter and the count of the valid communication counter.

In Example 6, the subject matter of one or any combination of Examples 1-5 optionally includes a sampling circuit coupled to the receiver and configured to sample an output of the receiver to detect the communication signal, and a control circuit configured to mask the output of the receiver for a signal masking time after the sampling time, wherein the signal masking time is a first masking time duration, decode a command received by the receiver to change the signal masking time to a second masking time duration, and mask the output of the receiver for the second masking time duration after the sampling time.

In Example 7, the subject matter of one or any combination of Examples 1-4 and 6 optionally includes a receiver including an AGC amplifier circuit configured to change signal gain according to magnitude of the communication signal based on a sensitivity gain curve of the AGC amplifier circuit, and a control circuit configured to change the signal gain curve of the AGC amplifier circuit in response to a command received by the receiver.

In Example 8, the subject matter of one or any combination of Examples 1-4 and 6 optionally includes a receiver including an AGC amplifier circuit configured to change signal gain according to magnitude of the communication signal based on a sensitivity gain curve of the AGC amplifier circuit, and a control circuit including a no-signal timer and is configured to change gain level of the AGC amplifier circuit when the no-signal timer exceeds a predetermined no-signal threshold time.

In Example 9, the subject matter of one or any combination of Examples 1-8 optionally includes a control circuit configured to perform firmware instructions included in firmware of the ambulatory medical device, perform a safety core of instructions when the performing of firmware instructions is disabled, and wherein the safety core of instructions are not changeable in the ambulatory medical device. The safety core of instructions includes instructions to cause the control circuit to decode a memory access command that includes a memory address, perform a memory access operation according to the memory access command, and encode a response to the memory access command and initiate sending the response when the performing the instructions included in firmware is disabled.

In Example 10, the subject matter of one or any combination of Examples 1-9 optionally includes a control circuit configured to perform firmware instructions included in firmware of the ambulatory medical device, decode a write command received by the receiver, wherein the write command includes a memory address, perform the write command when the memory address is within a specified memory address range of the memory, and not perform the write command when the memory address is outside the specified memory address range of the memory.

Example 11 includes a method of operating an inductive communication link of AMD, or can optionally be combined with one or any combination of Examples 1-10 to include such subject matter, comprising setting a receiver of a transceiver circuit of the inductive communication link to an active mode, setting the receiver to an inactive mode when a timeout timer expires and a communication signal is not detected by the receiver, wherein the timeout timer is set to a first timeout duration, maintaining the receiver in the active mode when the communication signal is detected by the receiver before the timeout timer set to the first timeout duration expires, receiving a command to set the timeout timer to a second timeout duration, and setting the receiver to the inactive mode when the timeout timer set to the second timeout duration expires and the communication signal is not detected.

In example 12, the subject matter of Example 11 optionally includes receiving, by the inductive communication link, a command to select a first type of communication signal to detect to maintain the receiver in the active mode, maintaining the receiver in the active mode when detecting the first type of communication signal, receiving a command to select a second type of communication signal to detect to maintain the receiver in the active mode, setting the receiver to the inactive mode when the timeout timer expires and the second type of communication signal is not detected, and maintaining the receiver in the active mode when detecting the second type of communication signal before the timeout timer expires.

In Example 13, the subject matter of Example 12, optionally includes the first type of communication signal being one of a communication signal including a peak with a magnitude greater than a specified signal detection magnitude, a communication signal including a predetermined synchronization character, or a communication signal including a valid command word, and the second type of communication signal being a different type of communication signal than the first type of communication signal.

In Example 14, the subject matter of one or any combination of Examples 11-13 optionally includes detecting the communication signal when detecting a peak in the communication signal having a first polarity, receiving a command to change to detecting the communication signal when detecting a peak in the communication signal having a second polarity, and maintaining the receiver in the active mode when detecting that the communication signal has the second polarity.

In Example 15, the subject matter of one or any combination of Examples 11-14 optionally includes incrementing an activation counter when detecting the communication signal and maintaining the receiver in the active mode, incrementing a valid communication counter when the communication signal is included in a valid communication, comparing a count of the activation counter and a count of the valid communication counter, and changing a signal sensitivity of the receiver according to a difference between the count of the activation counter and the count of the valid communication counter.

In Example 16, the subject matter of one or any combination of Examples 11-15 optionally includes receiving the communication signal using an antenna of the inductive communication link, sampling an output of the receiver at a sampling time to detect the communication signal, masking the output of the receiver for a signal masking time after the sampling time with the signal masking time being a first masking time duration, receiving (by the inductive communication link) a command to change the signal masking time to a second masking time duration, and masking the output of the receiver for the signal masking time after the sampling time, wherein the signal masking time is the second masking time duration.

In Example 17, the subject matter of one or any combination of Examples 11-16 optionally includes receiving the communication signal using an antenna of the inductive communication link and an automatic gain control (AGC) amplifier circuit connected to the antenna. The AGC amplifier circuit changes signal gain according to magnitude of the communication signal based on a sensitivity gain curve of the AGC amplifier circuit. The method further includes receiving a command to change the sensitivity gain curve of the AGC amplifier circuit, and changing signal gain according to magnitude of the communication signal based on a different sensitivity gain curve of the AGC amplifier circuit.

In Example 18, the subject matter of one or any combination of Examples 11-17 optionally includes performing instructions included in firmware of the ambulatory medical device, performing a safety core of instructions when the performing of firmware instructions is disabled (the safety core of instructions are not changeable in the ambulatory medical device), receiving a memory access command via the inductive communication link, wherein the memory access command includes a memory address, performing a memory access operation according to the memory access command using the safety core of instructions when the performing the instructions included in firmware is disabled, and sending a response to the memory access command using the inductive communication link when the performing the instructions included in firmware is disabled.

Example 19 includes subject matter (such as an ambulatory medical device) or can optionally be combined with one or any combination of Examples 1-18 to include such subject matter, comprising a coil antenna configured to receive a communication signal using mutual inductance, a transceiver circuit operatively coupled to the coil antenna and including a receiver configured to detect the communication signal, and a control circuit including a timeout timer. The control circuit is configured to perform firmware instructions included in firmware of the ambulatory medical device, and perform a safety core of instructions when the performing of firmware instructions is disabled. The safety core of instructions are not changeable in the ambulatory medical device and includes instructions to cause the control circuit to decode a memory access command that includes a memory address, perform the memory access operation, and encode a response to the memory access command and initiate sending the response when the performing the instructions included in firmware is disabled.

In Example 20, the subject matter of claim 19 optionally includes a safety core including instructions to cause the control circuit to set the receiver to an active mode and start the timeout timer, set the receiver to an inactive mode when the timeout timer expires and the communication signal is not detected by the receiver, and maintain the receiver in the active mode when the communication signal is detected by the receiver before the timeout timer expires.

The non-limiting Examples can be combined in any permutation or combination. This summary is intended to provide an overview of subject matter of the present patent application. It is not intended to provide an exclusive or exhaustive explanation of the disclosure. The detailed description is included to provide further information about the present patent application. Other aspects of the disclosure will be apparent to persons skilled in the art upon reading and understanding the following detailed description and viewing the drawings that form a part thereof, each of which are not to be taken in a limiting sense.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is an example of a patient management system.

FIG. 2 is an example of an ambulatory medical device (AMD).

FIG. 3 is diagram of telemetry circuits of an AMD.

FIG. 4 is a block diagram of an example of electronic circuits of an external device included in a patient management system.

FIG. 5 is a flow diagram of an example of a method of operating an inductive communication link of an AMD.

FIG. 6 illustrates a block diagram of an example machine upon which any one or more of the techniques discussed herein may perform.

### DETAILED DESCRIPTION

Ambulatory medical devices (AMDs), including implantable, subcutaneous, insertable, wearable, or one or more other medical devices, etc. AMDs can include, or be configured to receive physiologic information from, one or more sensors located within, on, or proximate to a body of a patient. Physiologic information of the patient can include, among other things, respiration information (e.g., a respiratory rate, a respiration volume (tidal volume), cardiac acceleration information (e.g., cardiac vibration information, pressure waveform information, heart sound information, endocardial acceleration information, acceleration information, activity information, posture information, etc.); impedance information; cardiac electrical information; physical activity information (e.g., activity, steps, etc.); posture or position information; pressure information; plethysmograph information; chemical information; temperature information; or other physiologic information of the patient. The present inventors have recognized, among other things, devices, systems, and methods to provide a customizable wireless telemetry link to transfer information between an AMD and a separate device.

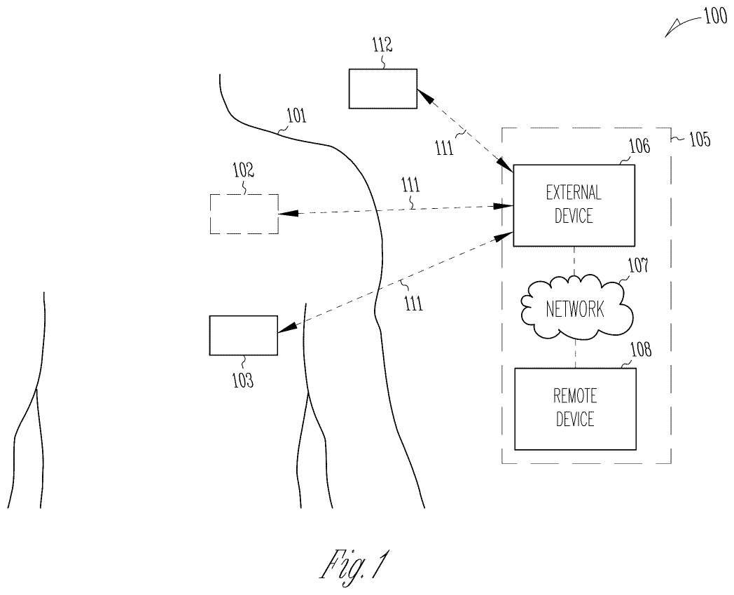

FIG. 1 illustrates an example patient management system 100 and portions of an environment in which the patient management system 100 may operate. The patient management system 100 can perform a range of activities, including remote patient monitoring and diagnosis of a disease condition. Such activities can be performed proximal to a patient 101, such as in a patient home or office, through a centralized server, such as in a hospital, clinic, or physician office, or through a remote workstation, such as a secure wireless mobile computing device.

The patient management system 100 can include one or more medical devices, an external system 105, and a communication link 111 providing for communication between the one or more ambulatory medical devices and the external system 105. The one or more medical devices can include an ambulatory medical device (AMD), such as an implantable medical device (IMD) 102, insertable cardiac monitor (ICM), a wearable medical device 103, or one or more other implantable, leadless, subcutaneous, external, wearable, or medical devices configured to monitor, sense, or detect information from, determine physiologic information about, or provide one or more therapies to treat various conditions of the patient 101, such as one or more cardiac or non-cardiac conditions (e.g., dehydration, sleep disordered breathing, etc.).

In an example, the IMD 102 of FIG. 1 can include one or more cardiac rhythm management devices implanted in a chest of a patient, having a lead system including one or more transvenous, subcutaneous, or non-invasive leads or catheters to position one or more electrodes or other sensors (e.g., a heart sound sensor) in, on, or about a heart or one or more other position in a thorax, abdomen, or neck of the patient 101. In another example, the IMD 102 can include a monitor implanted, for example, subcutaneously in the chest of patient 101, the IMD 102 including a housing containing circuitry and, in certain examples, one or more sensors, such as a temperature sensor, etc.

Cardiac rhythm management devices, such as insertable cardiac monitors, pacemakers, defibrillators, or cardiac resynchronizers, include implantable or subcutaneous devices having hermetically sealed housings configured to be implanted in a chest of a patient. The cardiac rhythm management device can include one or more leads to position one or more electrodes or other sensors at various locations in or near the heart, such as in one or more of the atria or ventricles of a heart, etc. Accordingly, cardiac rhythm management devices can include aspects located subcutaneously, though proximate the distal skin of the patient, as well as aspects, such as leads or electrodes, located near one or more organs of the patient. Separate from, or in addition to, the one or more electrodes or other sensors of the leads, the cardiac rhythm management device can include one or more electrodes or other sensors (e.g., a pressure sensor, an accelerometer, a gyroscope, a microphone, etc.) powered by a power source in the cardiac rhythm management device. The one or more electrodes or other sensors of the leads, the cardiac rhythm management device, or a combination thereof, can be configured detect physiologic information from the patient, or provide one or more therapies or stimulation to the patient.

Implantable devices can additionally or separately include leadless cardiac pacemakers (LCPs), small (e.g., smaller than traditional implantable cardiac rhythm management devices, in certain examples having a volume of about 1 cc, etc.), self-contained devices including one or more sensors, circuits, or electrodes configured to monitor physiologic information (e.g., heart rate, etc.) from, detect physiologic conditions (e.g., tachycardia) associated with, or provide one or more therapies or stimulation to the heart without traditional lead or implantable cardiac rhythm management device complications (e.g., required incision and pocket, complications associated with lead placement, breakage, or migration, etc.). In certain examples, leadless cardiac pacemakers can have more limited power and processing capabilities than a traditional cardiac rhythm management device; however, multiple leadless cardiac pacemakers can be implanted in or about the heart to detect physiologic information from, or provide one or more therapies or stimulation to, one or more chambers of the heart. The multiple leadless cardiac pacemakers can communicate between themselves, or one or more other implanted or external devices.

The IMD 102 can include an assessment circuit configured to detect or determine specific physiologic information of the patient 101, or to determine one or more conditions or provide information or an alert to a user, such as the patient 101 (e.g., a patient), a clinician, or one or more other caregivers or processes, such as described herein. The implantable medical device 102 can alternatively or additionally be configured as a therapeutic device configured to treat one or more medical conditions of the patient 101. The therapy can be delivered to the patient 101 via the lead system and associated electrodes or using one or more other delivery mechanisms. The therapy can include delivery of one or more drugs to the patient 101, such as using the implantable medical device 102 or one or more of the other ambulatory medical devices, etc. In some examples, therapy can include CRT for rectifying dyssynchrony and improving cardiac function in heart failure patients. In other examples, the implantable medical device 102 can include a drug delivery system, such as a drug infusion pump to deliver drugs to the patient for managing arrhythmias or complications from arrhythmias, hypertension, hypotension, or one or more other physiologic conditions. In other examples, the implantable medical device 102 can include one or more electrodes configured to stimulate the nervous system of the patient or to provide stimulation to the muscles of the patient airway, etc.

The wearable medical device 103 can include one or more wearable or external medical sensors or devices (e.g., automatic external defibrillators (AEDs), Holter monitors, patch-based devices, smart watches, smart accessories, wrist-or finger-worn medical devices, such as a finger-based photoplethysmography sensor, etc.).

The external system 105 can include a dedicated hardware/software system, such as a programmer, a remote server-based patient management system, or alternatively a system defined predominantly by software running on a standard personal computer. The external system 105 can manage the patient 101 through the implantable medical device 102 or one or more other ambulatory medical devices connected to the external system 105 via a communication link 111. In other examples, the IMD 102 can be connected to the wearable medical device 103, or the wearable medical device 103 can be connected to the external system 105, via the communication link 111. This can include, for example, programming the IMD 102 to perform one or more of acquiring physiologic data, performing at least one self-diagnostic test (such as for a device operational status), analyzing the physiologic data, or optionally delivering or adjusting a therapy for the patient 101. Additionally, the external system 105 can send information to, or receive information from, the IMD 102 or the wearable medical device 103 via the communication link 111. Examples of the information can include real-time or stored physiologic data from the patient 101, diagnostic data, such as detection of patient hydration status, hospitalizations, responses to therapies delivered to the patient 101, or device operational status of the implantable medical device 102 or the wearable medical device 103 (e.g., battery status, lead impedance, etc.). The communication link 111 can be an inductive telemetry link, a capacitive telemetry link, or a radio-frequency (RF) telemetry link, or wireless telemetry based on, for example, “strong” Bluetooth or IEEE 602.11 wireless fidelity “Wi-Fi” interfacing standards. Other configurations and combinations of patient data source interfacing are possible.

The external system 105 can include an external device 106 in proximity of the one or more ambulatory medical devices, and a remote device 108 in a location relatively distant from the one or more ambulatory medical devices, in communication with the external device 106 via a communication network 107. Examples of the external device 106 can include a medical device programmer. The remote device 108 can be configured to evaluate collected patient or patient information and provide alert notifications, among other possible functions. In an example, the remote device 108 can include a centralized server acting as a central hub for collected data storage and analysis from a number of different sources.

Combinations of information from the multiple sources can be used to make determinations and update individual patient status or to adjust one or more alerts or determinations for one or more other patients. The server can be configured as a uni-, multi-, or distributed computing and processing system. The remote device 108 can receive data from multiple patients. The data can be collected by the one or more ambulatory medical devices, among other data acquisition sensors or devices associated with the patient 101. The server can include a memory device to store the data in a patient database. The server can include an alert analyzer circuit to evaluate the collected data to determine if specific alert condition is satisfied. Satisfaction of the alert condition may trigger a generation of alert notifications, such to be provided by one or more human-perceptible user interfaces. In some examples, the alert conditions may alternatively or additionally be evaluated by the one or more ambulatory medical devices, such as the implantable medical device. By way of example, alert notifications can include a Web page update, phone or pager call, E-mail, SMS, text or “Instant” message, as well as a message to the patient and a simultaneous direct notification to emergency services and to the clinician. Other alert notifications are possible. The server can include an alert prioritizer circuit configured to prioritize the alert notifications. For example, an alert of a detected medical event can be prioritized using a similarity metric between the physiologic data associated with the detected medical event to physiologic data associated with the historical alerts.

The remote device 108 may additionally include one or more locally configured clients or remote clients securely connected over the communication network 107 to the server. Examples of the clients can include personal desktops, notebook computers, mobile devices, or other computing devices. System users, such as clinicians or other qualified medical specialists, may use the clients to securely access stored patient data assembled in the database in the server, and to select and prioritize patients and alerts for health care provisioning. In addition to generating alert notifications, the remote device 108, including the server and the interconnected clients, may also execute a follow-up scheme by sending follow-up requests to the one or more ambulatory medical devices, or by sending a message or other communication to the patient 101 (e.g., the patient), clinician or authorized third party as a compliance notification.

The communication network 107 can provide wired or wireless interconnectivity. In an example, the communication network 107 can be based on the Transmission Control Protocol/Internet Protocol (TCP/IP) network communication specification, although other types or combinations of networking implementations are possible. Similarly, other network topologies and arrangements are possible.

One or both of the external device 106 and the remote device 108 can output the detected medical events to a system user, such as the patient or a clinician, or to a process including, for example, an instance of a computer program executable in a microprocessor or other processor. In an example, the process can include an automated generation of recommendations for anti-arrhythmic therapy, or a recommendation for further diagnostic test or treatment. In an example, the external device 106 or the remote device 108 can include a respective display unit for displaying the physiologic or functional signals, or alerts, alarms, emergency calls, or other forms of warnings to signal the detection of arrhythmias. In some examples, the external system 105 can include an external data processor configured to analyze the physiologic or functional signals received by the one or more ambulatory medical devices, and to confirm or reject the detection of arrhythmias. Computationally intensive algorithms, such as machine-learning algorithms, can be implemented in the external data processor to process the data retrospectively to detect cardia arrhythmias.

Portions of the one or more ambulatory medical devices or the external system 105 can be implemented using hardware, software, firmware, or combinations thereof. Portions of the one or more ambulatory medical devices or the external system 105 can be implemented using an application-specific circuit that can be constructed or configured to perform one or more functions or can be implemented using a general-purpose circuit that can be programmed or otherwise configured to perform one or more functions. Such a general-purpose circuit can include a microprocessor or a portion thereof, a microcontroller or a portion thereof, or a programmable logic circuit, a memory circuit, a network interface, and various components for interconnecting these components. For example, a “comparator” can include, among other things, an electronic circuit comparator that can be constructed to perform the specific function of a comparison between two signals or the comparator can be implemented as a portion of a general-purpose circuit that can be driven by a code instructing a portion of the general-purpose circuit to perform a comparison between the two signals. “Sensors” can include electronic circuits configured to receive information and provide an electronic output representative of such received information.

The system includes a therapy device 112 that can be configured to send information to or receive information from one or more of the ambulatory medical devices or the external system 105 using the communication link 111. In an example, the one or more ambulatory medical devices, the external device 106, or the remote device 108 can be configured to control one or more parameters of the therapy device 112. The external system 105 can allow for programming the one or more ambulatory medical devices and can receives information about one or more signals acquired by the one or more ambulatory medical devices, such as can be received via a communication link 111. The external system 105 can include a local external implantable medical device programmer. The external system 105 can include a remote patient management system that can monitor patient status or adjust one or more therapies such as from a remote location.

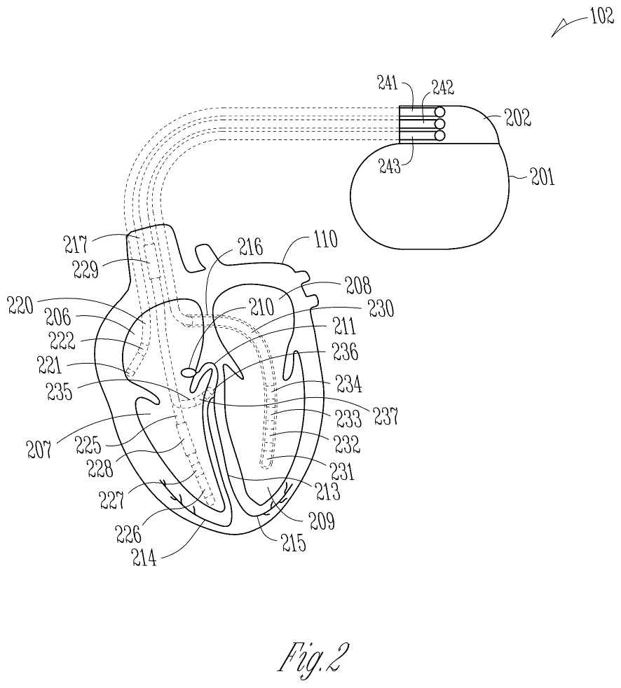

FIG. 2 illustrates an example of an ambulatory medical device that is an IMD 102. The IMD 102 is electrically coupled to a heart 110, such as through one or more leads coupled to the IMD 102 through one or more lead ports, such as first, second, or third lead ports 241, 242, 243 in a header 202 of the IMD 102. In an example, the IMD 102 can include an antenna, such as in the header 202, configured to enable communication with an external system and one or more electronic circuits in a hermetically sealed housing (CAN) 201. The IMD 102 illustrates an example medical device (or a medical device system) as described herein.

The IMD 102 may be an implantable cardiac monitor (ICM), pacemaker, defibrillator, cardiac resynchronizer, or other subcutaneous IMD or cardiac rhythm management (CRM) device configured to be implanted in a chest of a subject, having one or more leads to position one or more electrodes or other sensors at various locations in or near the heart 110, such as in one or more of the atria or ventricles. Separate from, or in addition to, the one or more electrodes or other sensors of the leads, the IMD 102 can include one or more electrodes or other sensors (e.g., a pressure sensor, an accelerometer, a gyroscope, a microphone, etc.) powered by a power source in the IMD 102. The one or more electrodes or other sensors of the leads, the IMD 102, or a combination thereof, can be configured detect physiologic information from, or provide one or more therapies or stimulation to, the patient.

The IMD 102 can include one or more electronic circuits configured to sense one or more physiologic signals, such as an electrogram or a signal representing mechanical function of the heart 110. In certain examples, the CAN 201 may function as an electrode such as for sensing or pulse delivery. For example, an electrode from one or more of the leads may be used together with the CAN 201 such as for unipolar sensing of an electrogram or for delivering one or more pacing pulses. A defibrillation electrode (e.g., the first defibrillation coil electrode 228, the second defibrillation coil electrode 229, etc.) may be used together with the CAN 201 to deliver one or more cardioversion/defibrillation pulses.

In an example, the IMD 102 can sense impedance such as between electrodes located on one or more of the leads or the CAN 201. The IMD 102 can be configured to inject current between a pair of electrodes, sense the resultant voltage between the same or different pair of electrodes, and determine impedance, such as using Ohm's Law. The impedance can be sensed in a bipolar configuration in which the same pair of electrodes can be used for injecting current and sensing voltage, a tripolar configuration in which the pair of electrodes for current injection and the pair of electrodes for voltage sensing can share a common electrode, or tetrapolar configuration in which the electrodes used for current injection can be distinct from the electrodes used for voltage sensing, etc. In an example, the IMD 102 can be configured to inject current between an electrode on one or more of the first, second, third, or fourth leads 220, 225, 230, 235 and the CAN 201, and to sense the resultant voltage between the same or different electrodes and the CAN 201.

The example lead configurations in FIG. 2 include first, second, and third leads 220, 225, 230 in traditional lead placements in the right atrium (RA) 206, right ventricle (RV) 207, and in a coronary vein 216 (e.g., the coronary sinus) over the left atrium (LA) 208 and left ventricle (LV) 209, respectively, and a fourth lead 235 positioned in the RV 207 near the His bundle 211, between the AV node 210 and the right and left bundle branches 212, 213 and Purkinje fibers 214, 215. Each lead can be configured to position one or more electrodes or other sensors at various locations in or near the heart 110 to detect physiologic information or provide one or more therapies or stimulation.

The first lead 220, positioned in the RA 206, includes a first tip electrode 221 located at or near the distal end of the first lead 220 and a first ring electrode 222 located near the first tip electrode 221. The second lead 225 (dashed), positioned in the RV 207, includes a second tip electrode 226 located at or near the distal end of the second lead 225 and a second ring electrode 227 located near the second tip electrode 226. The third lead 230, positioned in the coronary vein 216 over the LV 209, includes a third tip electrode 231 located at or near the distal end of the third lead 230, a third ring electrode 232 located near the third tip electrode 231, and two additional electrodes 233, 234. The fourth lead 235, positioned in the RV 207 near the His bundle 211, includes a fourth tip electrode 236 located at or near the distal end of the fourth lead 235 and a fourth ring electrode 237 located near the fourth tip electrode 236. The tip and ring electrodes can include pacing/sensing electrodes configured to sense electrical activity or provide pacing stimulation.

In addition to tip and ring electrodes, one or more leads can include one or more defibrillation coil electrodes configured to sense electrical activity or provide cardioversion or defibrillation shock energy. For example, the second lead 225 includes a first defibrillation coil electrode 228 located near the distal end of the second lead 225 in the RV 207 and a second defibrillation coil electrode 229 located a distance from the distal end of the second lead 225, such as for placement in or near the superior vena cava (SVC) 217.

Different CRM devices include different number of leads and lead placements. For examples, some CRM devices are single-lead devices having one lead (e.g., RV only, RA only, etc.). Other CRM devices are multiple-lead devices having two or more leads (e.g., RA and RV; RV and LV; RA, RV, and LV; etc.). CRM devices adapted for His bundle pacing often use lead ports designated for LV or RV leads to deliver stimulation to the His bundle 211.

The IMD 102 is battery-powered and can communicate to an external device (e.g., external device 106 in FIG. 1) using a communication link (e.g., the communication link 111 in FIG. 1). The communication link can be an inductive communication link. The communication link provides for data transmission from IMD 102 to the external device. This can include, for example, transmitting real-time physiological data acquired by IMD 102, extracting physiological data acquired by and stored in the IMD 102, extracting therapy history data stored in the IMD 102, or extracting data indicating an operational status of the IMD 102 (e.g., battery status and lead impedance). Communication link also provides for data transmission from the external device to the IMD 102. This can include, for example, programming the IMD 102 to acquire physiological data, programming the IMD 102 to perform at least one self-diagnostic test (such as for a device operational status), or programming the IMD to deliver one or more therapies.

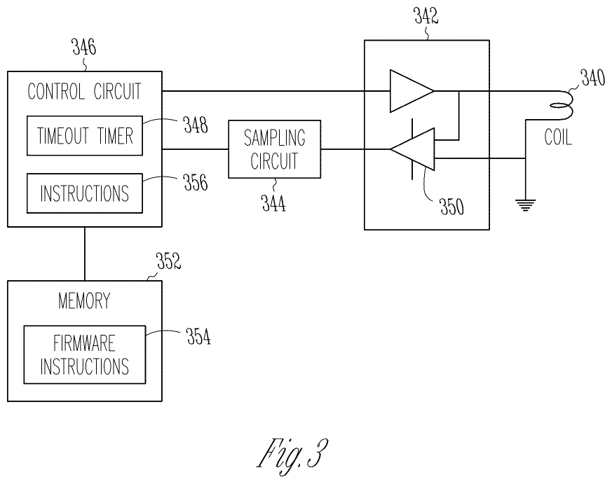

FIG. 3 is a diagram of portions of an example of circuits of an inductive communication link of an AMD (e.g., any of the AMDs described herein). The inductive communication link includes a near field coil antenna 340 and a transceiver circuit 342 that includes a transmitter and a receiver. In the IMD 102 of FIG. 2, the coil antenna 340 can be included in the header 202 or around the periphery of the CAN 201. The external device that communicates with the AMD (e.g., external device 106 in FIG. 1) also includes a near field coil antenna. Energy may be transferred from the external device to the telemetry circuits via mutual inductance linking the two coil antennas. Data is transferred by sending data bits over the inductive communication link. The AMD includes a control circuit 346. The control circuit 346 may be implemented using an application-specific integrated circuit (ASIC) constructed to perform one or more functions or a general-purpose circuit programmed to perform the functions. A general-purpose circuit can include, among other things, a microprocessor or a portion thereof, a microcontroller or portions thereof, and a programmable logic circuit or a portion thereof. The control circuit 346 controls the mode of the inductive communication link (e.g., between transmitting and receiving).

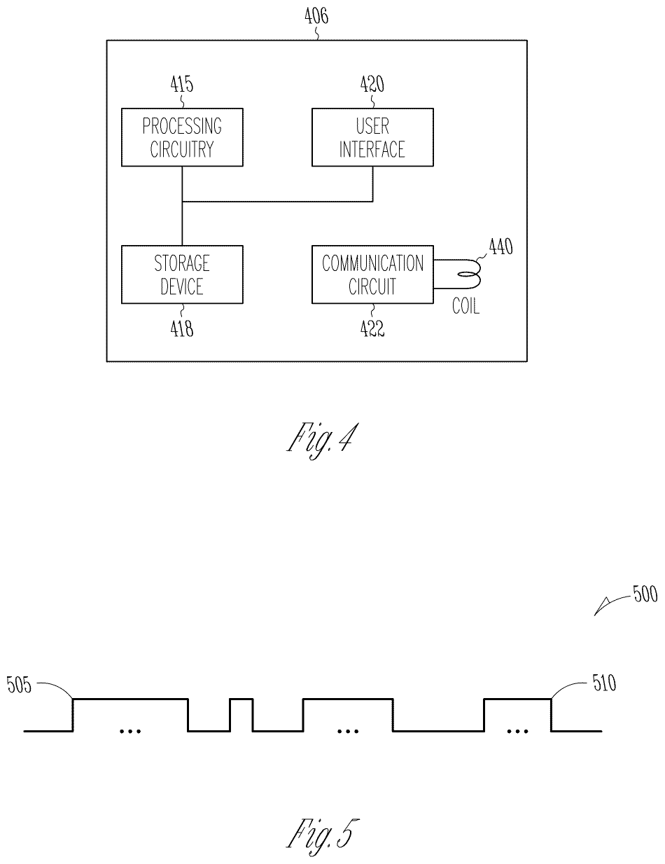

FIG. 4 is a block diagram of an example of portions of an external device 406 included in an external system (e.g., external system 105 in FIG. 1). The external device 406 includes a storage device 418 and processing circuitry 416. In some examples, the external device 406 includes a user interface 420. Processing circuitry 416 may be implemented using an ASIC constructed to perform one or more functions or a general-purpose circuit programmed to perform the functions. The storage device 418 may be a memory integral to the processing circuitry 416, or a separate memory device. The device 406 includes a communication circuit 422 to communicate information with another device. Communication circuit 422 is operatively coupled to inductive coil antenna 440 and may communicate information wirelessly with the inductive communication link of FIG. 3 using near-field inductive wireless signals. The external device 406 can be used to program pacing therapy parameters and other information in an AMD.

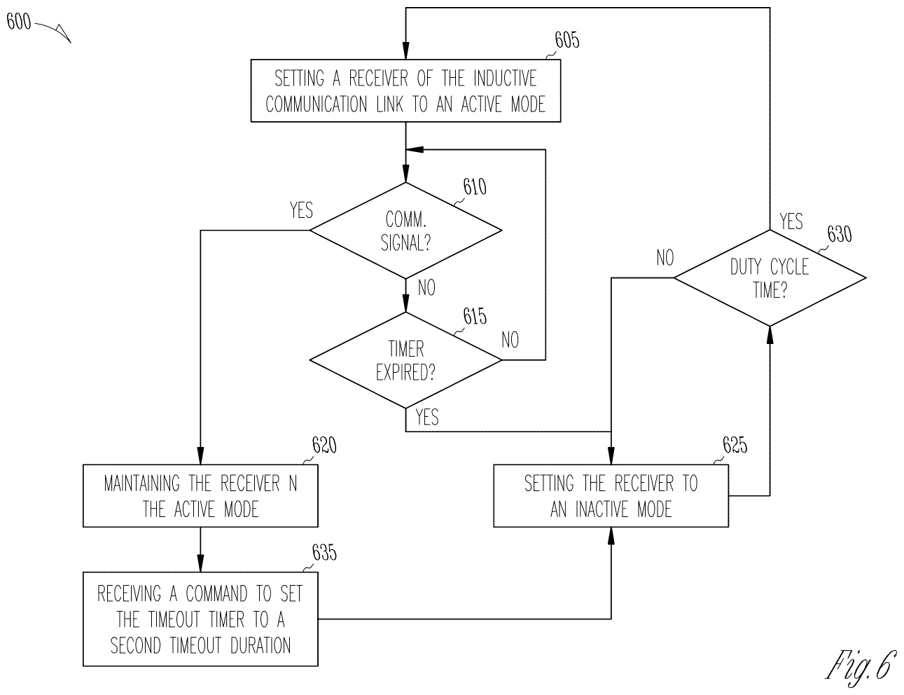

FIG. 5 is a conceptual illustration of a timing diagram of a communication signal 500 incoming to the AMD and the transceiver circuit 342 of FIG. 3. The communication signal 500 represents a demodulated data signal incoming to the IMD. The communication link can include a sampling circuit 344 to translate the communication signal 500 into bits of data. The sampling circuit 344 detects an edge transition 505 and, at a specified time from the edge based on the bit rate, samples the communication signal 500 to determine binary “1”s and “0”s between edge transition 505 and edge transition 510. In the transmit mode, the transceiver circuit energizes the near field coil antenna 340 which is detected by the external device. Energy on the coil represents binary “1”s and an absence of energy represents binary “0”s. In this way, the communication link is a serial communication link.

If the AMD is an implantable device, the range of the communication may need to vary with the depth of the implantation. One way to increase range of the communication link is to increase the sensitivity of the receiver of the transceiver circuit. However, increasing the sensitivity of the receiver involves increasing the operating current, and because the AMD is battery powered, the increased operating current can impact the battery life of the AMD.

FIG. 6 is a flow diagram of an example of a method 600 of operating an inductive communication link of an AMD. The method 600 involves the control circuit 346 duty cycling the receiver when there is no communication with the AMD. The duty cycling alternates the inductive communication link of the AMD between an active mode in which the receiver is powered and an inactive mode in which the receiver is not powered. When communication is active and a communication signal is present, the receiver is powered and the control circuit 346 does not duty cycle the receiver.

At block 605, the control circuit 346 sets the receiver of the transceiver circuit 342 to the active mode. In the active mode, power is provided to the circuits of the receiver. In certain examples, all the circuits in the transceiver circuit are powered in the active mode. The active mode allows the receiver to detect a communication signal from a separate device such as the external device 406 of FIG. 4. When the control circuit 346 starts the active mode, it starts a timeout timer 348. If the receiver detects a communication signal at block 610 before the timeout timer 348 expires at block 615, at block 620 the control circuit 346 maintains the receiver in the active mode to continue a communication session. The control circuit 346 may extend the timeout timer 348. If the receiver does not detect a communication signal before the timeout timer 348 expires at block 615, at block 625 the control circuit 346 sets the receiver to the inactive mode. At block 630, the receiver remains in the inactive mode until the duty cycle time when the receiver is reactivated by the control circuit 346 to the active mode to look for a communication signal.

One or both of the timeout timer 348 and the duty cycle time are programmable by the external device 406 of FIG. 4 sending timing values to the AMD over the inductive communication link. For example, at block 635, a command is received over the inductive communication link to change the time duration of the timeout timer from the current time duration to a second time duration. In response to the command, the control circuit 346 changes the time duration and the communication session ends. At block 625, the control circuit 346 sets the receiver to the inactive mode at the end of the communication session. At the duty cycle time the control circuit 346 sets the receiver to the active mode at block 605. Because of the programming, the control circuit 346 now sets the receiver to the inactive mode at block 615 when the timeout timer 348 expires after the second timeout duration. The timeout time and the duty cycling time may be timed using separate timers or the same timer.

Other parameters for detection of the communication signal that prevents the timeout and maintains the receiver in the active mode may also be programmable. For instance, the receiver includes an amplifier circuit 350. The amplifier circuit 350 detects a communication signal having a magnitude greater than a specified detection magnitude. The sensitivity of the amplifier circuit 350 can be programmable to detect communication signals having smaller magnitude to maintain the active mode. The polarity of the detection may also be programmable.

As discussed previously herein, the sampling circuit 344 may be designed to detect an edge of the communication signal. In the example of FIG. 5, the polarity of the first edge transition 505 of the communication signal is a positive going edge. The positive going edge may be from a positive going first peak of an inductive signal on the near-field coil antenna 340. The control circuit 346 can be programmable to detect a communication having a negative going first edge caused by a negative going first peak. Thus, the polarity of the communication signal that maintains the receiver in the active mode may be programmable. The first peak typically has the largest magnitude in the inductive signal. Changing the polarity of the detection can increase the sensitivity of the inductive communication link. The control circuit 346 may decode a command to change one or more parameters for detection of the communication signal that maintains the inductive communication link in the active mode. The command may be to change the sensitivity of the receiver amplifier circuit 350 or to change the polarity of the detection. The control circuit 346 changes the parameters in response to decoding the command.

The control circuit 346 may use a programmable masking time when sampling the output of the receiver. If the signal on near field coil antenna 340 is extremely strong, the receiver amplifier circuit 350 may become saturated for too long and the sampling circuit 344 may produce incorrect data. The control circuit 346 may mask or ignore the output of the sampling circuit 344 or the receiver amplifier circuit 350 for the duration of the masking time. The duration of the masking time is programmable and the control circuit 346 changes the masking time when decoding a command from the external device to change the masking time.

According to some examples, the receiver amplifier circuit 350 is an automatic gain control (AGC) amplifier. The AGC amplifier changes signal gain according to the magnitude of the communication signal based on a sensitivity gain curve of the AGC amplifier. The sensitivity gain curve automatically applies a larger signal gain to a communication signal with a smaller magnitude and applies a smaller signal gain to a communication signal with a larger magnitude. The sensitivity gain curve may be programmable. Different sensitivity gain curves may apply larger or smaller signal gain to a communication signal of the same amplitude, or different sensitivity gain curves may change the signal gain faster or slower to the same change in magnitude of the communication signal. The control circuit 346 may configure a different sensitivity gain curve for the AGC amplifier in response to receiving a command to change the sensitivity gain curve for the AGC amplifier.

In some examples, the control circuit 346 determines a no-signal time of not detecting a communication signal. The duration of the no-signal time can be determined using the timeout timer 348 or another timer. The no-signal time may include multiple iterations of duty cycling the inductive communication link without receiving any communication signal. The signal time expires when the timer reaches a predetermined no signal time threshold. When the no signal time expires, this may indicate that a current communication session is over or paused. The control circuit 346 may decrease the gain level of the AGC after the no signal time expires to reduce current used by the inductive communication link. The gain level may be changed during a device transmission. The no signal time threshold may be programmable. The control circuit 346 changes the predetermined no signal time threshold from a current time duration to a new time duration when receiving a command to do so from the external device.

Different types of communication signals can be used to prevent the timeout and maintain the receiver in the active mode. The type of communication signal that maintains the receiver in the active mode may also be programmable. In some examples, the communication signal that maintains the receiver in the active mode only needs to have a magnitude greater than a minimum magnitude. In some examples, the communication signal needs to include more information to maintain the communication link in the active mode.

For instance, the communication signal may need to include a predetermined synchronization character to maintain the receiver in the active mode. A synchronization character can be used to indicate the start of a communication session or to indicate word or frame boundaries in the communicated data. An example of a synchronization character is a “comma character” that has a value of “1100000101.” Decoding the comma character by the control circuit 346 may cause the control circuit 346 to maintain the receiver in the active mode and to enable other circuits of the inductive communication link or to wake-up other circuits in the AMD. In another example, the communication signal may need to include a valid command word to maintain the communication link in the active mode.

The control circuit 346 may implement one or more diagnostic counters to monitor the performance of the inductive communication link. The diagnostic counters may be used to determine if excessive power is being used by the configuration of the inductive communication link. Some examples of diagnostic counters include an activation counter and a valid communication counter. The activation counter is incremented whenever the control circuit 346 detects a communication signal and stops duty cycling the receiver and maintains the receiver in the active mode. The valid communication counter is incremented when the communication signal is part of a valid communication between the external device and the AMD (e.g., when a valid command is received by the AMD). In some examples, the activation counter is decremented after a time duration in which no signal is detected.

The control circuit 346 may periodically compare the count of the activation counter to the count of the valid communication counter. If the activation counter is much greater than the valid communication counter, this may indicate that the inductive communication link is experiencing excessive wakeups. If the activation counter is greater than the valid communication counter by more than a threshold count, the control circuit 346 may change the signal sensitivity of the receiver (e.g., by reducing the gain on the receiver amplifier circuit 350). If the count values of the activation counter and the valid communication counter are too low, this may indicate that too few communication sessions were started, and the inductive communication link is having trouble recognizing attempts to communicate with the AMD. The control circuit 346 may increase the sensitivity of the receiver when the values of the counters are less than a predetermined threshold count value.

The AMD includes a memory 352 that can be separate from the control circuit 346 or integral to the control circuit 346. The memory 352 may store the values of the programmable parameters for the inductive communication link, including the programmable sensitivity parameters and the programmable parameters used by the control circuit 346 to detect communication signals. The control circuit 346 writes the values of the programmable parameters in the memory 352 in response to commands from the external device. The control circuit 346 also reads data from the memory 352 to send to the external device. The memory also stores firmware instructions 354 that are performed by the control circuit 346. The firmware instructions 354 are changeable and are stored in the memory 352 during manufacturing of the AMD. In certain examples, the firmware instructions may be changed after manufacturing using the inductive communication link.

The control circuit 346 executes firmware instructions 354 to write data to the memory 352 and read data from the memory 352 in response to write and read commands from the external device. In some examples, the firmware instructions 354 only allow memory writes to a specific memory address range in response to a write command received using the inductive communication link. Memory writes outside the allowed memory address range are ignored or otherwise not performed. The firmware instructions 354 may include sending a response to the external device that the write command was not performed. Preventing access to certain memory addresses can be useful to prevent third party devices from directly changing operating parameters of the AMD or firmware of the AMD.

In general, the control circuit 346 executes the firmware instructions 354 to perform the functions of the control circuit 346 described herein. As a precaution, the AMD also includes a safety core of instructions 356 that are not included in the firmware instructions 354 and are not changeable. The control circuit 346 performs the safety core instructions 356 when the executing of firmware instructions 354 becomes disabled. For instance, the control circuit 346 may include a watchdog timer periodically reset by the firmware instructions 354. If the watchdog timer expires this may mean that execution of firmware instructions 354 has become disabled, and the control circuit 346 switches to executing the safety core instructions 356 when the watchdog timer expires.

The safety core instructions 356 can include reduced functionality from the firmware instructions 354 to reliably avoid whatever condition caused the firmware instructions 354 to become disabled. For instance, if the AMD is an implantable pacemaker, switching from the firmware instructions 354 to the safety core instructions 356 may involve the AMD changing from performing pacing according to NASPE/BPEG-defined DDD mode to the VOO mode.

The safety core instructions 356 can include instructions that allow the external device to read and write memory 352 even though execution of the firmware instructions is disabled. This allows the external device to still write and read memory locations and registers, and control operation of the AMD without using firmware. The write and read operations of the safety core instructions 356 can provide a tool for determining the root cause of the problem if firmware becomes disabled. In some examples, memory access commands from the external device are performed by the control circuit 346 using firmware instructions 354 when the firmware is enabled, and the memory access commands are performed using the safety core instructions 356 when the executing the firmware is disabled.

The several examples of telemetry operating modes described herein allow the inductive communication link of an AMD to be customizable for a particular implant. Instead of designing the sensitivity and the operating current of the communication link for a worst-case scenario, the operating current used by the inductive communication link can be optimized to have reduced impact on battery life and provide the best performance for the patient. For instance, operating current may be different for a device that treats bradycardia and a device that treats tachycardia, and optimizing operating current may be more beneficial for one type of device than another.

Various embodiments are illustrated in the figures above. One or more features from one or more of these embodiments may be combined to form other embodiments. Method examples described herein can be machine or computer-implemented at least in part. Some examples may include a computer-readable medium or machine-readable medium encoded with instructions operable to configure an electronic device or system to perform methods as described in the above examples. An implementation of such methods can include code, such as microcode, assembly language code, a higher-level language code, or the like. Such code can include computer readable instructions for performing various methods. The code can form portions of computer program products. Further, the code can be tangibly stored on one or more volatile or non-volatile computer-readable media during execution or at other times.

The term “transmission medium” includes any intangible medium that is capable of storing, encoding, or carrying instructions for execution by a machine, and includes digital or analog communications signals or other intangible medium to facilitate communication of such software. A transmission medium is a machine-readable medium.

The above detailed description is intended to be illustrative, and not restrictive. The scope of the disclosure should, therefore, be determined with references to the appended claims, along with the full scope of equivalents to which such claims are entitled.

What is claimed is:

1. An ambulatory medical device, the device comprising:
a coil antenna configured to receive a communication signal using mutual inductance;
a transceiver circuit operatively coupled to the coil antenna and including a receiver configured to detect the communication signal;
a control circuit including a timeout timer, wherein the control circuit is configured to:
set the receiver to an active mode;
set the receiver to an inactive mode when the timeout timer expires after a timeout duration and the communication signal is not detected by the receiver; and
maintain the receiver in the active mode when the communication signal is detected by the receiver before the timeout timer expires.

2. The device of claim 1, wherein the control circuit is configured to:
maintain the receiver in the active mode when a first specified type of communication signal is detected before the timeout timer expires;
decode a command received by the receiver to select a second specified type of communication signal to detect to maintain the receiver in the active mode;
set the receiver to the inactive mode when the timeout timer expires and the second specified type of communication signal is not detected; and
maintain the receiver in the active mode when detecting the second specified type of communication signal before the timeout timer expires.

3. The device of claim 2,
wherein the first specified type of communication signal is one of a communication signal including a peak with a magnitude greater than a specified signal detection magnitude, a communication signal including a predetermined synchronization character, or a communication signal including a valid command word; and
wherein the second specified type of communication signal is a different type of communication signal than the first type of communication signal.

4. The device of claim 1, wherein the control circuit is configured to:
maintain the receiver in the active mode when the communication signal includes a peak having a first polarity;
decode a command received by the receiver to change to detecting the communication signal when detecting a peak in the communication signal having a second polarity; and
maintain the receiver in the active mode when detecting that the communication signal has the second polarity.

5. The device of claim 1,
wherein the receiver includes an automatic gain control (AGC) amplifier circuit having adjustable gain; and
wherein the control circuit is configured to:
increment an activation counter when detecting the communication signal and maintaining the receiver in the active mode;
increment a valid communication counter when the communication signal is included in a valid communication with the ambulatory medical device;
compare a count of the activation counter and a count of the valid communication counter; and
change the gain of the AGC amplifier circuit according to a difference between the count of the activation counter and the count of the valid communication counter.

6. The device of claim 1, including:
a sampling circuit coupled to the receiver and configured to sample an output of the receiver to detect the communication signal;
wherein the control circuit is configured to:
mask the output of the receiver for a signal masking time after the sampling time, wherein the signal masking time is a first masking time duration;
decode a command received by the receiver to change the signal masking time to a second masking time duration; and
mask the output of the receiver for the second masking time duration after the sampling time.

7. The device of claim 1,
wherein the receiver includes an automatic gain control (AGC) amplifier circuit configured to change signal gain according to magnitude of the communication signal based on a sensitivity gain curve of the AGC amplifier circuit;
wherein the control circuit is configured to change the signal gain curve of the AGC amplifier circuit in response to a command received by the receiver.

8. The device of claim 1,
wherein the receiver includes an automatic gain control (AGC) amplifier circuit having adjustable gain; and
wherein the control circuit includes a no-signal timer and is configured to change gain level of the AGC amplifier circuit when the no-signal timer exceeds a predetermined no-signal threshold time.

9. The device of claim 1, wherein the control circuit is configured to:
perform firmware instructions included in firmware of the ambulatory medical device;
perform a safety core of instructions when the performing of firmware instructions is disabled, wherein the safety core of instructions are not changeable in the ambulatory medical device and includes instructions to cause the control circuit to:
decode a memory access command that includes a memory address;
perform a memory access operation according to the memory access command; and
encode a response to the memory access command and initiate sending the response when the performing the instructions included in firmware is disabled.

10. The device of claim 1, wherein the control circuit is configured to:
perform firmware instructions included in firmware of the ambulatory medical device;
decode a write command received by the receiver, wherein the write command includes a memory address;
perform the write command when the memory address is within a specified memory address range of the memory; and
not perform the write command when the memory address is outside the specified memory address range of the memory.

11. A method of operating an inductive communication link of an ambulatory medical device, the method comprising;
setting a receiver of a transceiver circuit of the inductive communication link to an active mode;
setting the receiver to an inactive mode when a timeout timer expires and a communication signal is not detected by the receiver, wherein the timeout timer is set to a first timeout duration; and
maintaining the receiver in the active mode when the communication signal is detected by the receiver before the timeout timer set to the first timeout duration expires.

12. The method of claim 11, including:
receiving, by the inductive communication link, a command to select a first type of communication signal to detect to maintain the receiver in the active mode;
maintaining the receiver in the active mode when detecting the first type of communication signal;
receiving a command to select a second type of communication signal to detect to maintain the receiver in the active mode;
setting the receiver to the inactive mode when the timeout timer expires and the second type of communication signal is not detected; and
maintaining the receiver in the active mode when detecting the second type of communication signal before the timeout timer expires.

13. The method of claim 12,
wherein the first type of communication signal is one of a communication signal including a peak with a magnitude greater than a specified signal detection magnitude, a communication signal including a predetermined synchronization character, or a communication signal including a valid command word; and
wherein the second type of communication signal is a different type of communication signal than the first type of communication signal.

14. The method of claim 11, including:
detecting the communication signal when detecting a peak in the communication signal having a first polarity;
receiving a command to change to detecting the communication signal when detecting a peak in the communication signal having a second polarity; and
maintaining the receiver in the active mode when detecting that the communication signal has the second polarity.

15. The method of claim 11, including:
incrementing an activation counter when detecting the communication signal and maintaining the receiver in the active mode;
incrementing a valid communication counter when the communication signal is included in a valid communication;
comparing a count of the activation counter and a count of the valid communication counter; and
changing a signal sensitivity of the receiver according to a difference between the count of the activation counter and the count of the valid communication counter.

16. The method of claim 11, including:
receiving the communication signal using an antenna of the inductive communication link;
sampling an output of the receiver at a sampling time to detect the communication signal;
masking the output of the receiver for a signal masking time after the sampling time, wherein the signal masking time is a first masking time duration;
receiving, by the inductive communication link, a command to change the signal masking time to a second masking time duration; and
masking the output of the receiver for the signal masking time after the sampling time, wherein the signal masking time is the second masking time duration.

17. The method of claim 11, including:
receiving the communication signal using an antenna of the inductive communication link and an automatic gain control (AGC) amplifier circuit connected to the antenna, wherein the AGC amplifier circuit changes signal gain according to magnitude of the communication signal based on a sensitivity gain curve of the AGC amplifier circuit;
receiving a command to change the sensitivity gain curve of the AGC amplifier circuit; and
changing signal gain according to magnitude of the communication signal based on a different sensitivity gain curve of the AGC amplifier circuit.

18. The method of claim 11, the method comprising:
performing instructions included in firmware of the ambulatory medical device;
performing a safety core of instructions when the performing of firmware instructions is disabled, wherein the safety core of instructions are not changeable in the ambulatory medical device;
receiving a memory access command via the inductive communication link, wherein the memory access command includes a memory address;
performing a memory access operation according to the memory access command using the safety core of instructions when the performing the instructions included in firmware is disabled; and
sending a response to the memory access command using the inductive communication link when the performing the instructions included in firmware is disabled.

19. An ambulatory medical device, the device comprising:
a coil antenna configured to receive a communication signal using mutual inductance;
a transceiver circuit operatively coupled to the coil antenna and including a receiver configured to detect the communication signal; and
a control circuit configured to:
perform firmware instructions included in firmware of the ambulatory medical device; and
perform a safety core of instructions when the performing of firmware instructions is disabled, wherein the safety core of instructions are not changeable in the ambulatory medical device and includes instructions to cause the control circuit to:
decode a memory access command that includes a memory address;
perform the memory access operation; and
encode a response to the memory access command and initiate sending the response when the performing the instructions included in firmware is disabled.

20. The device of claim 19,
wherein the control circuit includes a timeout timer; and
wherein the safety core of instructions includes instructions to cause the control circuit to:
set the receiver to an active mode and start the timeout timer;
set the receiver to an inactive mode when the timeout timer expires and the communication signal is not detected by the receiver, and
maintain the receiver in the active mode when the communication signal is detected by the receiver before the timeout timer expires.
